(19) United States
(12) Patent Application Publication
(10) Pub. No.: US 2001/0034618 A1
(43) Pub. Date: Oct. 25, 2001

(54) Healthcare payment and compliance system

(76) Inventors: David G. Kessler, Cherry Hill, NJ (US); Michael F. White, Haddonfield, NJ (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/769,758

(22) Filed: Jan. 26, 2001

Related U.S. Application Data
(60) Provisional application No. 60/184,765, filed on Feb. 24, 2000.

(51) Int. Cl. G06F 17/60

(52) U.S. Cl. 705/4; 705/2

(57) ABSTRACT

A system, method, and computer program product for health care payment and compliance are described herein. The system, method, and computer program product facilitate compliance with rules governing coverage by a third party payor for health care provided to a beneficiary by a provider. Compliance with the rules is aimed at simplifying and accelerating the process of providing health care to beneficiaries and insuring reimbursement to providers by third party payors. A third party payor provides its rules governing health care coverage to the system of the present invention. A beneficiary then orders from a provider a health care product or service which is administered under the medical benefit. The system then applies the provided coverage rules to determine the level of coverage by the third party payor for the order. Based on this determination, the provider can automatically bill the third party payor for the portion of the value of the order covered by the third party payor. Upon application of the provided coverage rules, the system converts the product codes submitted by the provider to more specific product codes. The converted product codes are then provided to the third party payor. The system can be applied to ancillary health care administered under the medical benefit.

### RELATED U.S. APPLICATION DATA

This patent application claims priority to U.S. Provisional Application No. 60/184,765 to Kessler, entitled “Health Care Payment and Compliance System,” filed Feb. 24, 2000. The foregoing U.S. Provisional Application is hereby incorporated by reference in its entirety.

### BACKGROUND OF THE INVENTION

1. Field of the Invention

The present invention relates generally to management systems, and more particularly to computer-based systems that facilitate compliance with rules governing coverage by a third party payor for health care provided to a beneficiary.

2. Background Art

In the health care industry, unlike other industries, most products and services are provided to one party (the “beneficiary”) and paid for by another (the “third party payor”). Third party payors include, without limitation, insurance companies, third party administrators, insurance intermediaries, government entities, hospital systems, integrated delivery networks, network managers, outpatient clinics, extended care facilities, pharmacy benefit managers, disease management companies and home health agencies. As the health care industry evolves, new entities may begin accepting the position of third party payor. Examples of such entities include manufacturers, call centers, and internet providers such as self-help web sites, general content providers and e-commerce suppliers and networks.

Third party payors base payment for products and services on compliance with thousands of complex rules that govern everything from basic coverage to medical necessity. These rules (“the rules”) fall into three categories: General Coverage (GC), Health Plan Coverage (HPC) rules and Specific Payment Criteria (SPC). GC rules generally define when health insurance coverage will apply. GC rules include information such as whether the beneficiary has insurance and the identification number of the beneficiary. HPC rules define what type of coverage is available to the beneficiary. HPC rules include information regarding the specific health plan in which the beneficiary is enrolled, as well as the third party payor of the beneficiary. HPC rules also include co-payment information, deductible information and authorization information. SPC rules define the specific scope of the coverage available to the beneficiary. SPC rules include information regarding whether, in the judgment of the third party payor, the product or service being provided to the beneficiary, or the amount of the product, is appropriate and whether the product or service should be paid for as a benefit.

Currently, GC information is typically available to beneficiaries, individuals and companies that provide health care products and services to the beneficiary (“providers”). This facilitates the application and compliance with the GC rules. HPC information, however, is not currently available to beneficiaries and providers in its entirety. This hinders the application of and compliance with the HPC rules. This, in turn, leads to delays and confusion in obtaining authorization of benefits. In addition, the little HPC information that is available is often inconsistent and too general. SPC information is also not typically available to providers and beneficiaries. This hinders the application of and compliance with the SPC rules. This, in turn, leads to delays in reimbursing the provider or the beneficiary for covered health care. The hindrance of the application of and compliance with the rules poses an obstacle for the beneficiary to quickly and efficiently obtain health care products and services that are covered by the third party payor.

Additionally, the automatic, or computerized, application of the rules is typically only available for health care administered through the pharmacy benefit. That is, automatic compliance with the rules is generally only available for beneficiaries buying drugs or other prescriptive devices from providers. The lack of such a system for the medical benefit, and ancillary health care administered under the medical benefit, leads to an increase in manual claim processing and longer billing cycles for components of the health care industry that administer the medical benefit.

Therefore, given the foregoing, what is needed is a system, method, and computer program product for health care payment and compliance applicable to all health care benefits. The system, method, and computer program product should facilitate compliance with rules governing coverage by a third party payor for all health care benefits provided to a beneficiary by a provider.

### BRIEF SUMMARY OF THE INVENTION

The present invention meets the above-mentioned needs by providing a system, method, and computer program product and combinations and sub-combinations thereof for health care payment and compliance. The invention facilitates compliance with rules governing coverage by a third party payor for health care provided to a beneficiary by a provider. Compliance with the rules is aimed at simplifying and accelerating the process of providing health care to beneficiaries and insuring reimbursement to providers by third party payors.

In an embodiment of the present invention, a third party payor provides its rules governing health care coverage to the system of the present invention.

Subsequently, a beneficiary or a provider orders from a provider a health care product or service administered under the medical benefit. The present invention then applies the provided coverage rules to determine the level of coverage by the third party payor for the order. Based on this determination, the provider can automatically bill the third party payor for the portion of the value of the order covered by the third party payor. The provider can also automatically bill the beneficiary for the portion of the value of the order not covered by the third party payor. The provider can then fulfill the order to the beneficiary.

In an embodiment of the present invention, the provider can automatically receive payment for the provided health care from the third party payor.

In an embodiment of the present invention, the applied coverage rules include protocol rules, healing outcome rules and economic outcome rules. In another embodiment of the present invention, the applied coverage rules further include formulary rules, utilization rules, authorization rules, co-payment rules and deductible rules.

In another embodiment of the present invention, future orders are automatically processed based on an initial determination of coverage by a third party payor.

In another embodiment of the present invention, upon application of the provided coverage rules, the system of the present invention converts the product codes submitted by the provider to more specific product codes. The converted product codes are then provided to the third party payor.

In another embodiment of the present invention, the system of the present invention is applied towards ancillary health care administered under the medical benefit, including: durable medical equipment, enteral nutrition, incontinence products, ostomy products, respiratory products, injectable drugs, infusion services, home health care services, wound care management, diabetes management, disease management, health condition management and other specialty health care management.

Embodiments of the present invention include an application service provider model and a stand-alone application program which allows providers to facilitate their own compliance with rules governing health care coverage.

One advantage of the present invention is that health care coverage is verified automatically which results in the immediate provision of health care to the beneficiary. This also results in the immediate assurance that a provider will be reimbursed for health care provided to the beneficiary. This is beneficial to both the beneficiary and the provider as it affirms that neither the provider nor the beneficiary will be left liable for the value of the provided health care.

Another advantage of the present invention is that the third party payor can be automatically billed by the provider for the provided health care. Further, the third party payor can automatically pay the provider for the provided health care. This is beneficial to the beneficiary as it accelerates the process of obtaining health care and it eliminates the confusion as to who is liable for provided health care. This is beneficial to the provider as it reduces the burden of creating and sending a bill to the third party payor. This is beneficial to the third party payor as it allows for quick and timely accounting assessments.

Another advantage of the present invention is that the application of rules governing health care coverage includes protocol rules, healing outcome rules and economic outcome rules. This is beneficial to the beneficiary as well as the third party payor as it insures that the beneficiary is receiving the most appropriate health care while being cost efficient.

Another advantage of the present invention is that the application of rules governing health care coverage includes formulary rules, utilization rules, authorization rules, co-payment rules and deductible rules. This is beneficial to the beneficiary as it insures that he is receiving the most appropriate health care. This is also beneficial to the beneficiary as it allows for automatic verification of health care coverage and, thus, immediate provision of health care to the beneficiary.

Another advantage of the present invention is that medical documentation supporting an order is automatically provided to the third party payor. This is beneficial to the beneficiary and the third party payor as it allows for quick and efficient adjudication of a claim.

Another advantage of the present invention is that the application of rules governing health care coverage can be applied to the medical benefit and ancillary health care administered under the medical benefit. That is, the system of the present invention is uniquely suited to providers administering health care via the medical benefit. This is beneficial to the beneficiary as it allows for the efficient provision of a wider range of health care.

Another advantage of the present invention is that future orders are automatically processed based on an initial determination of coverage by a third party payor. This is beneficial to the beneficiary, the third party payor and the provider as it eliminates the need for numerous requests for a recurring order.

This decreases the burden of order processing and claim adjudication.

Another advantage fo the present invention is that third party payors can obtain more specific information regarding covered products. Upon receipt of more specific product codes that define the exact product and product quantities that are being provided to beneficiaries, the third party payor is better equipped to meet the needs of beneficiaries. This allows the third party payor to provide better service to beneficiaries and the beneficiaries to obtain less expensive health care.

Further features and advantages of the invention as well as the structure and operation of various embodiments of the present invention are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1A is a block diagram illustrating the system architecture of an embodiment of the present invention, showing connectivity among the various components;

FIG. 1B is a block diagram illustrating the current architecture of an embodiment of the pharmacy benefit component of the health care industry, showing connectivity among the various components;

FIG. 1C is a block diagram illustrating the architecture of an embodiment of the medical benefit component of the health care industry, in an embodiment of the present invention, showing connectivity among the various components;

FIG. 2 is a block diagram illustrating the system architecture of an alternative Application Service Provider embodiment of the present invention, showing connectivity among the various components;

FIG. 3 is a block diagram illustrating the system architecture of an alternative Resident Application Program embodiment of the present invention, showing connectivity among the various components;

FIG. 4 is a diagram illustrating an embodiment of the various rules that may be executed by the present invention;

FIG. 5A is a flowchart depicting an embodiment of the operation and control flow of the Health Care Payment and Compliance System of the present invention;

FIG. 5B is a flowchart depicting an alternative embodiment of the operation and control flow of the Health Care Payment and Compliance System of the present invention;

FIG. 5C is a continuation flowchart of FIG. 5B, depicting an alternative embodiment of the operation and control flow of the Health Care Payment and Compliance System of the present invention;

FIG. 5D is a chart depicting an embodiment of utilization guidelines for ostomy care, in an embodiment of the present invention.

FIG. 5E is a chart depicting an embodiment of a product code mapping, in an embodiment of the present invention.

FIG. 6 is a flowchart depicting an embodiment of the operation and control flow of the rules application of the Health Care Payment and Compliance System present invention;

FIG. 7 is a flowchart depicting a more detailed embodiment of the operation and control flow of the rules application of the Health Care Payment and Compliance System present invention;

FIG. 8 is a flowchart depicting a more detailed embodiment of the operation and control flow of a single rule application of the Health Care Payment and Compliance System present invention;

FIG. 9 is a flowchart depicting an embodiment of the operation and control flow of the payment processing of the Health Care Payment and Compliance System present invention; and

FIG. 10 is a block diagram illustrating the system architecture of an embodiment of a computer system and computer program product, showing connectivity among the various components, that may be used to implement the present invention.

The present invention will now be described with reference to the accompanying drawings.

### DETAILED DESCRIPTION OF THE INVENTION

### Table of Contents

I. Overview

A. Definitions

B. System Architecture

C. Pharmacy Benefit System

D. Example System

E. General Considerations

II. Business Models

A. Application Service Provider Model

B. Resident Application Model

III. Compliance Rules

IV. System Operation

A. Application Service Provider Model

B. Rules Application

1. Decisions and Rules Sets

2. Individual Rules

C. Payment Processing

D. Alternative System Operation

E. Product Tracking Module

VII. Example Implementations

VIII. Conclusion

I. Overview

The present invention relates to a system, method, and computer program product and combinations and sub-combinations thereof for health care payment and compliance.

A. Definitions

The following definitions are provided for illustrative purposes only.

Alternative definitions for the listed terms will be apparent to the persons skilled in the relevant art(s) based on the discussion contained herein, and fall within the scope and spirit of embodiments of the invention.

The term “HCPACS” is used to refer to the Health Care Payment and Compliance System of the present invention.

The term “health care” is generally used to refer to the provision of health care products and health care services to an individual or a group of individuals.

Health care services include medical procedures, physician visits, nursing, home-based health-related services and other medical attention. Health care products include drugs, medical supplies, medical products and medical devices.

The term “health plan” is used to refer to a program which provides health care to an individual or a group of individuals. An example of a health plan is the commonly available health insurance plan by which an individual pays monthly premiums to a health insurance company and in return receives health care. Examples of a health insurance plan include a health maintenance organization (HMO), a preferred provider organization (PPO) or a quality point of service (QPOS) plan.

The term “beneficiary” is used to refer to an individual who receives the benefits of a health plan. For example, the beneficiary of a health insurance plan is usually the individual who pays the monthly premiums.

The term “third party payor” is used to refer to an individual or business entity which is financially liable for health care provided to a beneficiary. The third party payor is usually a health care company or organization which provides a health plan to a beneficiary. An example of a third party payor is a health insurance company which pays for health care provided to a beneficiary. Further examples of third party payors are shown in Table 1.

TABLE 1
Third Party Payors

insurance companies
third party administrators
insurance intermediaries
government entities
hospital systems
integrated delivery networks
network managers
outpatient clinics
extended care facilities
pharmacy benefit managers
disease management companies
home health agencies
manufacturers
call centers
internet providers

self-help web sites
e-commerce suppliers
e-commerce networks
general content providers

The term “provider” is used to refer to an individual or business entity which provides health care to a beneficiary. The provider is usually reimbursed for the provided health care by a third party payor. An example of a provider is a hospital emergency room which provides health care to a beneficiary of a health plan.

The terms “coverage” or “cover” are used to refer to the financial liability of a third party payor for health care provided to a beneficiary. There can be varying levels of coverage. A third party payor can be liable for the entire value of health care provided to a beneficiary or only for a portion of the entire value.

The level of coverage for health care is typically determined by applying “the rules” (defined below).

The term “benefit” is used to refer to the type of coverage offered to a beneficiary. A health plan, such as a health insurance plan, typically offers a pharmacy benefit (which includes coverage for drugs, prescriptive devices and related products) and a medical benefit (which includes coverage for doctors visits, emergency room visits and all other medical services and products). Ancillary health care (which includes coverage for products and services that are ancillary to the medical benefit) is administered under the medical benefit.

Examples of ancillary health care are shown in Table 2.

TABLE 2
Ancillary Health Care

Durable medical equipment
Enteral nutrition
Incontinence products
Ostomy products
Respiratory products
Injectable drugs
Infusion services
Home health care services
Wound care management

services
products

Diabetes management

services
products

Disease management

services
products

Health condition management

services
products

Other specialty health care management

services
products

The term “rule” is used to refer to a syllogism which comprises a condition (or conditions) and an action (or actions). Typically, the actions must be executed if the conditions are met. In the scope of this application, a rule is used to refer to a health care rule which defines the use of health care and the corresponding level of coverage provided by a third party payor for the health care provided to a beneficiary. One example of a rule is: If the beneficiary requires emergency room care, the health insurance company will cover the value of the visit. Another example of a rule is: If a beneficiary requires orthotic inserts, the health insurance company will cover 50% of the value of the orthotic inserts.

The term “the rules” is used to refer to a group of rules that are applied by a third party payor to determine the level of coverage owed to a beneficiary for provided health care. The rules typically take into account a wide array of information including the type of health plan of the beneficiary, the disease or condition of the beneficiary, etc. The rules can include GC rules, HPC rules and SPC rules.

The term “formulary rule” is used to refer to a rule which is associated with the brand of health care product that should be provided to a beneficiary. A formulary rule can assert, for example, the brand of gauze which is preferred by a third party payor. An example of a formulary rule is a rule which asserts that Acme brand gauze is preferred by a health insurance company.

The term “utilization rule” is used to refer to a rule which is associated with the quantity of a health care product that should be administered to a beneficiary. A utilization rule can assert, for example, how much gauze is to be used for a particular wound. An example of a utilization rule is a rule which asserts that 2 pieces of Acme brand gauze is to be used per day to dress a particular type of wound.

The term “economic outcome rule” is used to refer to a rule which is associated with the most economically beneficial course of action. An example of an economic outcome rule is a rule which asserts that the most economically beneficial course of action for a beneficiary with a particular wound is to dress the wound with Acme brand gauze.

The term “healing outcome rule” is used to refer to a rule which is associated with the most therapeutically beneficial course of action. An example of an healing outcome rule is a rule which asserts that the most therapeutically beneficial course of action for a beneficiary with a particular wound is to dress the wound with Beta brand gauze.

The term “protocol rule” is used to refer to a rule which is associated with the best medical practice as determined by a medical professional. A protocol rule includes information garnered from economic outcome rules and healing outcome rules, thus taking economic and therapeutic issues into account. An example of a protocol rule is a rule which asserts that the best medical practice for a beneficiary with a particular wound is to dress the wound with Acme brand gauze.

The term “authorization rule” is used to refer to a rule which is associated with the conditions under which a beneficiary can obtain approval for health care from a third party payor. An authorization rule defines whether approval may be sought for certain health care provided to a beneficiary. An example of an authorization rule is a rule which asserts that a beneficiary with a full health plan can seek approval for an orthopedic aid device.

The term “co-payment rule” is used to refer to a rule which is associated with the financial liability of a beneficiary for provided health care. A co-payment rule usually defines a monetary amount which the beneficiary must pay to a provider when health care is provided. A co-payment rule may also a monetary amount which a secondary insurance of a beneficiary must pay to a provider when health care is provided to the beneficiary. An example of a co-payment rule is a rule which asserts that a beneficiary must pay $10 for every visit to his primary care physician.

The term “deductible rule” is used to refer to a rule which is associated with a monetary amount that must be paid by a beneficiary before coverage is provided to the beneficiary by the third party payor. An example of a deductible rule is a rule which asserts that a beneficiary must first pay a total of $100 for provided health care before the third party payor becomes financially liable for the health care provided to the beneficiary.

The terms “client,” “subscriber,” “entity,” “business concern,” and the plural form of these terms are used interchangeably throughout herein to refer to those who would access the HCPACS of the present invention. A client or subscriber can be a beneficiary, a provider or any other interested entity.

The term “HCPCS” is used to refer to Health Care Product Code System.

This is a coding scheme promulgated by Medicare for the purpose of identifying health care products. HCPCS codes are rather general and do not distinguish products having different attributes, such as brand or material.

The term “SKU” is used to refer to a Stock Keeping Unit. This is an alternative coding scheme used to identify products.

The term “NDC” is used to refer to a National Drug Code. This is an alternative coding scheme used to identify products.

The term “UPC” is used to refer to a Universal Product Code. This is an alternative coding scheme used to identify products.

The term “HIPAA” is used to refer to the Health Insurance Portability and Accountability Act of 1997. This act passed by Congress was designed to enable the development of standardization and growth of new efficient systems technology in health care. For example, HIPAA mandated that providers of Medicare beneficiaries must bill Medicare using HCPCS codes.

B. System Architecture

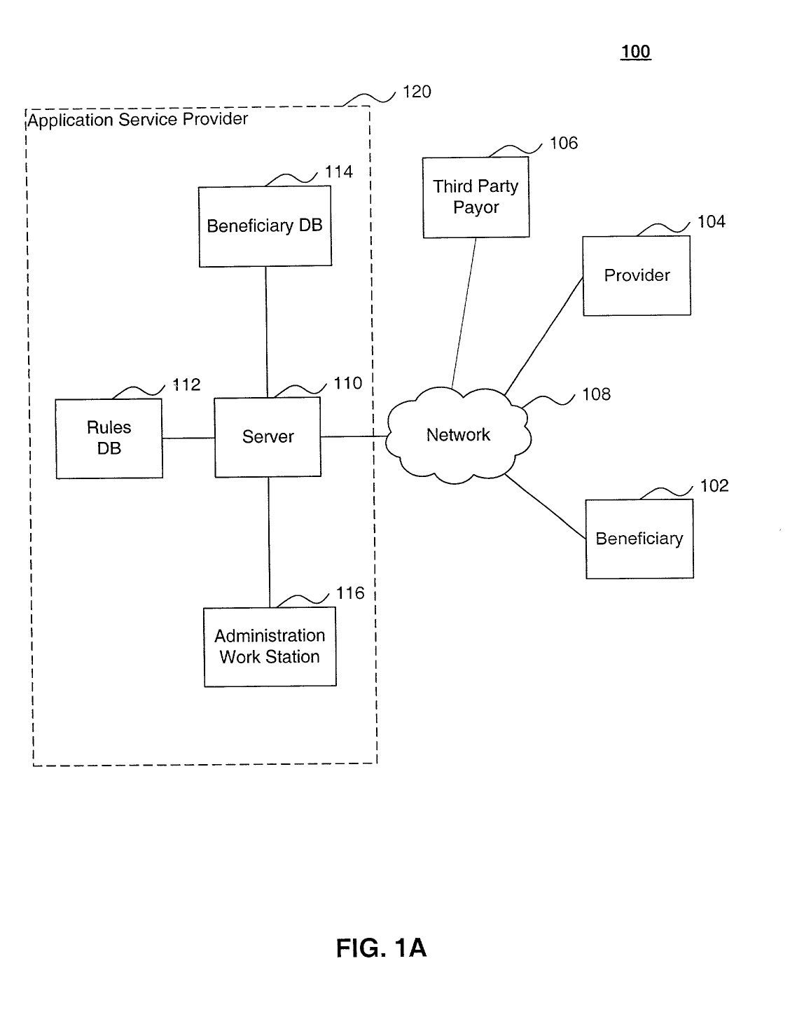

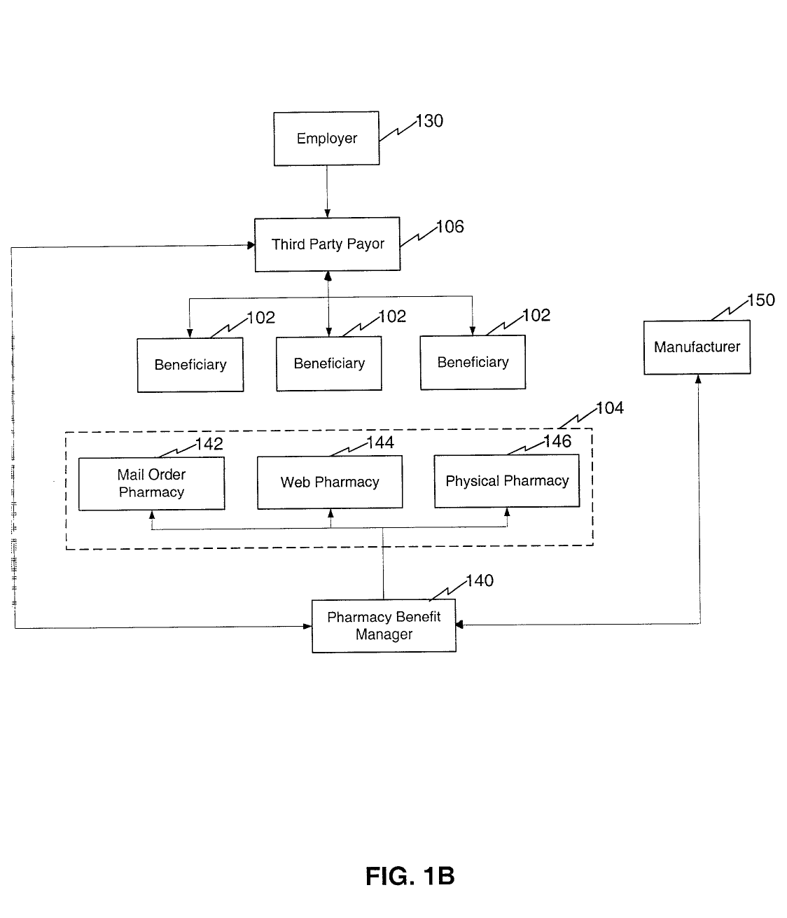

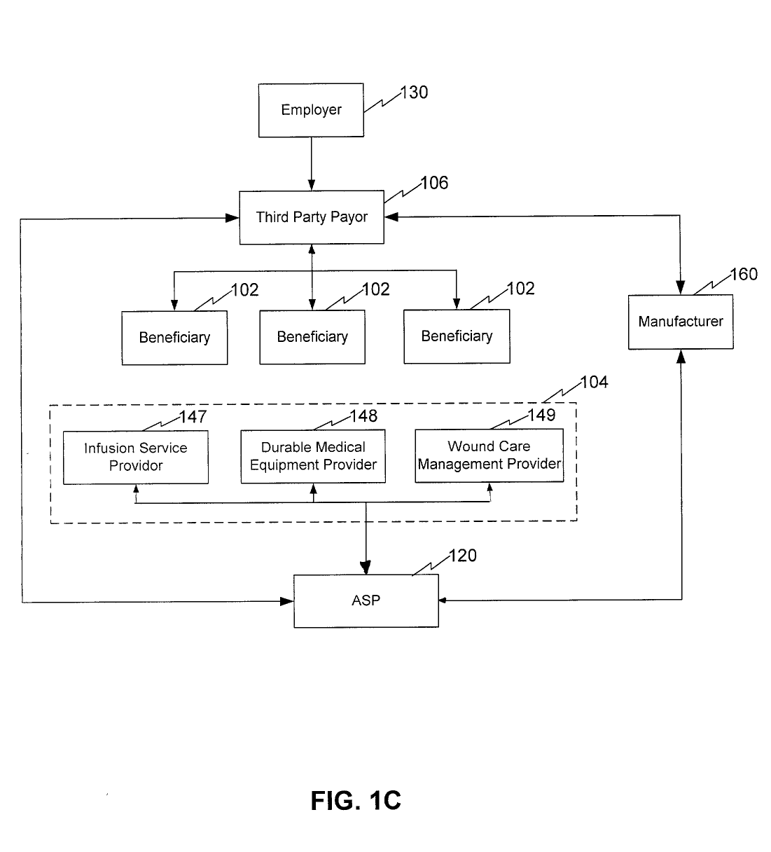

Referring to FIG. 1A, a block diagram illustrating the physical architecture of a Health Care Payment and Compliance System (HCPACS) 100, according to an embodiment of the present invention is shown. FIG. 1A also shows connectivity among the various components of system 100. The embodiment of FIG. 1A represents the ASP model of the HCPACS. The ASP model is described in greater detail below.

HCPACS 100 includes a beneficiary 102, a provider 104, a third party payor 106, an application service provider 120 and network 108. Beneficiary 102 can be an individual with access to a computer or other network-capable device. Provider 104 and third party payor 106 can be an individual or a business entity with access to a computer or other network-capable device. Application service provider 120 includes server 110 and administration workstation 116. In addition, application service provider 120 includes a rules database 112 and a beneficiary database 114, which are each explained in more detail below. In one preferred embodiment, network 108 is a packet switched wide area network (WAN) such as the global Internet. Network 108 can alternatively be a private wide area network (WAN), a local area network (LAN), a telecommunications network or any combination of the above-mentioned networks.

The databases 112 and 114 are connected to server 110 which serves as the “back-bone” (i.e., the HCPACS processing) and the “front-end” of the present invention. In an embodiment of the present invention, server 110 is one or more SUN Ultra workstations running the SunOS™ operating system. In another embodiment, server 110 is one or more IBM™ or compatible personal computer (PC) workstations with an Intel® Pentium® III processor running either the Windows NT™ operating system or the BSD Unix operating system.

Server 110 is further connected to network 108 which serves as the communications medium between the ASP and the ASP's clients (e.g., third party payor 106 and provider 104). The same medium allows communication between beneficiary 102 and provider 104. While only one beneficiary 102, only one third party payor 106 and only one provider 104 are shown in FIG. 1A for ease of explanation, it will be apparent to one skilled in the relevant art(s) that HCPACS 100 may support a plurality of beneficiaries 102, third party payors 106 and providers 104.

As will be also apparent to one skilled in the relevant art(s) after reading the description herein, clients of HCPACS 100 can interact with the system via one or more connection devices. For example, network 108 may be the Internet (i.e., TCP/IP) where e-commerce activities are conducted between application service provider 120 and provider 104. In such an embodiment, provider 104 utilizes a device such as a PC (e.g., an IBM™ or compatible PC workstation running the Microsoft® Windows 95/98™ or Windows NT™ operating system, Macintosh® computer running the Mac® OS operating system, or the like), or any network connection device, such as atelephone, to communicate with application service provider 120. Specific examples of connection devices are shown in Table 3.

TABLE 3
Connection Devices

telephone
mobile phone
fax
computer
game console
interactive television
PDA

Further, clients of HCPACS 100 can interact with the system via numerous connection mechanisms such as a Web site or an interactive voice response system. Specific examples of connection mechanisms are shown in Table 4. Thus, after reading the following description, it will be apparent to one skilled in the relevant art(s) how to implement the following invention in alternative embodiments to facilitate compliance with rules governing coverage by a third party payor for health care provided to a beneficiary by a provider using each exemplary connection device listed in Table 3 and each exemplary connection mechanism listed in Table 4.

TABLE 4
Connection Mechanisms

Human operator
Interactive Voice Response
Electronic Data Interchange
Web site access
File Transfer Protocol
Email

HCPACS 100 also includes an administrative workstation 116 connected to server 110. This workstation can be used by personnel of application service provider 120 to upload, update, and maintain subscriber information (e.g., logins, passwords, etc.) and health care-related data and rules for each of the clients that subscribe to HCPACS 100. Administrative workstation 116 may also be used to monitor and log statistics related to server 110 and HCPACS 100 in general. Also, administrative workstation 116 may be used “off-line” by clients of HCPACS 100 in order to enter configuration data and rules. This data is eventually stored in databases 112 and 114 as described in detail below.

Components 110, 112, 114 and 116 of HCPACS 100 (i.e., those components that the ASP would have as part of their infrastructure), as will be apparent to one skilled in the relevant art(s), are connected and communicate via a wide or local area network (WAN or LAN) running a secure communications protocol (e.g., secure sockets layer (SSL)).

It should be understood that the particular embodiments of HCPACS 100, as shown in FIG. 1A, are for illustrative purposes only and do not limit the present invention. For example, while separate databases (i.e., databases 112 and 114) are shown in FIG. 1A for ease of explanation, it will be apparent to one skilled in the relevant art(s) that HCPACS 100 may utilize databases physically located on one or more computers which may or may not be the same as server 110, as applicable. In an embodiment of the present invention, these databases can also be mirrored for fault tolerance purposes. In yet another embodiment, HCPACS 100 can contain separate databases 112 and 114 for each of its clients or interested parties.

More detailed descriptions of HCPACS 100 components, as well their functionality and inter-functionality with other HCPACS 100 components, are provided below.

C. Pharmacy Benefit System

Referring to FIG. 1B, a block diagram of the current architecture of an embodiment of the pharmacy benefit component of the health care industry is shown. FIG. 1B also shows connectivity among the various elements that together allow a health plan to administer the pharmacy benefit to beneficiaries. FIG. 1B represents the prior art embodiment of the pharmacy benefit component of the health care industry.

FIG. 1B shows employer 130 as the entity through which beneficiaries 102 obtain a health plan provided by a third party payor 106. As an alternative, beneficiaries 102 can obtain a health plan from the goverinent or directly from a health insurance company. FIG. 1B further shows pharmacy benefit manager (PBM) 140, which is contracted by third party payor 106 to administer the pharmacy benefit to beneficiaries 102. In administering the pharmacy benefit, PBM 140 contracts with providers 104 to provide the particular health care products relating to the pharmacy benefit (in this instance, drugs and prescriptive devices) to the beneficiaries 102. Providers 104 can be a mail order pharmacy 142, a web pharmacy 144, a physical pharmacy 146 or any provider which can provide drugs or prescriptive devices to beneficiaries 102. PBM 140 can also contract with a manufacturer 150 to provide drugs or prescriptive devices to providers 104.

The function of PBM 140 is to administer the pharmacy benefit to beneficiaries 102. This encompasses a variety of tasks. PBM 140 works with third party payors 106 to set up appropriate coverage rules regarding the pharmacy benefit. In doing so, PBM 140 receives from third party payor 106 the rules which it must apply when determining coverage for a beneficiary 102 under the health plan offered by third party payor 106 to that beneficiary 102. PBM 140 typically only supports the application of Formulary Rules, Authorization Rules, Co-Payment Rules and Deductible Rules.

PBM 140 contracts with providers 104 to provide drugs and prescriptive devices to beneficiaries 102. PBM 140 also works with providers 104 to insure compliance with rules governing coverage of the pharmacy benefit. In doing so, PBM 140 receives order intake information (via any connection device or connection mechanism described in Table 3 and Table 4) from beneficiary 102 (via provider 104) at the point of purchase. Order intake procedures are described in greater detail below. PBM 140 then automatically applies the rules and conveys to provider 104 (via any connection device or connection mechanism described in Table 3 and Table 4) whether beneficiary 102 is covered by his health plan. Provider 104 may then immediately provide the drug or prescriptive device to beneficiary 102 and automatically bill PBM 140 (via any connection device or connection mechanism described in Table 3 and Table 4) for the health care provided to beneficiary 102. PBM 140 may then automatically pay provider 104. Currently, billing and payment is performed via Electronic Data Interchange and other protocols such as Hyper Text Transfer Protocol.

PBM 140 can also contract with manufacturers 150 to provide drugs and prescriptive devices to providers 104. Via this level of contact with manufacturers 150, PBM 140 can negotiate for lower prices and better service in exchange for selling the products of the manufacturer. This translates to efficient and more affordable health care for beneficiaries 102.

D. Example System

Referring to FIG. 1C, a block diagram of the architecture of an example of the medical benefit component of the health care industry, in an embodiment of the present invention, is shown. FIG. 1C also shows connectivity among the various elements that together allow a health plan to administer the medical benefit to beneficiaries. FIG. 1C represents the application of an embodiment of the present invention to the medical benefit component of the health care industry.

FIG. 1C shows employer 130 as the entity through which beneficiaries 102 obtain a health plan provided by a third party payor 106. As an alternative, beneficiaries 102 can obtain a health plan from the government or directly from a health insurance company. FIG. 1C further shows ASP 120, which is contracted by third party payor 106 to administer the medical benefit to beneficiaries 102. In administering the medical benefit, ASP 120 allows providers 104 to access its HCPACS 100 in order to comply with the rules and ensure payment by third party payor 106. Providers 104 can be an infusion service provider 147, a durable medical equipment provider 148, a wound care management provider 149 or any provider which can provide medical benefits to beneficiaries 102. Table 2 shows additional examples of medical benefits—specifically ancillary health care administered under the medical benefit. ASP 120 can also contract with a manufacturer 160 to provide medical benefit products to providers 104.

The function of ASP 120, much like PBM 140 above, is to administer the medical benefit to beneficiaries 102. This encompasses a variety of tasks. ASP 120 works with third party payors 106 to set up appropriate coverage rules regarding the medical benefit. In doing so, ASP 120 receives from third party payor 106 the rules which it must apply when determining coverage for a beneficiary 102 under the health plan offered by third party payor 106 to that beneficiary 102. In addition to the rules that are normally applied by a PBM 140 (as described above), ASP 120 can apply all rule types, including: Formulary Rules, Utilization Rules, Protocol Rules, Economic Outcome Rules, Healing Outcome Rules, Authorization Rules, Co-Payment Rules and Deductible Rules. The different rule types are described in greater detail below.

ASP 120 can contract with providers 104 to provide medical benefit products and services to beneficiaries 102. ASP 120 can also work with providers 104 to insure compliance with rules governing coverage of the medical benefit. In doing so, ASP 120 receives order intake information from beneficiary 102 (via provider 104) at the point of purchase. Order intake procedures are described in greater detail below. ASP 120 then automatically applies the rules and conveys to provider 104 whether beneficiary 102 is covered by his health plan. Provider 104 may then immediately provide the medical benefit products and services to beneficiary 102 and automatically bill third party payor 106 for the health care provided to beneficiary 102. Third party payor 106 may then automatically pay provider 104.

ASP 120 can also contract with manufacturers 160 to provide medical benefit products and services to providers 104. Via this level of contact with manufacturers 160, ASP 120 can negotiate for lower prices and better service in exchange for selling the products of the manufacturer. In an example, ASP 120 can contract to include the product of a manufacturer 160 in a Formulary Rule in exchange for the provision of the product to providers 104 at a lower price. In this example, ASP 120 is providing greater exposure to the product of manufacturer 160, while providers 104 are receiving less costly products. This translates to efficient and more affordable health care for beneficiaries 102.

E. General Considerations

In sum, the present invention solves the above-described inefficiency problem by providing a system, method and computer program product to quickly and easily guide a client to comply with the rules governing coverage for health care. The present invention allows a beneficiary, provider or other interested entities to maintain compliance with the rules and enable efficient reception of health care by beneficiaries and payment processing.

The present invention is described in terms of the examples contained herein. This is for convenience only and is not intended to limit the application of the present invention. In fact, after reading the following description, it will be apparent to one skilled in the relevant art(s) how to implement the following invention in alternative embodiments.

II. Business Models

A. Application Service Provider Model

In one embodiment of the present invention, an application service provider (ASP) provides and allows access, perhaps on a subscription or per-use basis, to the HCPACS via the global Internet or other connection. That is, the application service provider would provide the hardware (e.g., servers) and software (e.g., database) infrastructure, application software, database files, customer support, and billing mechanism to allow its clients (e.g., beneficiaries, providers and other interested entities) to facilitate compliance with rules governing coverage by a third party payor for health care provided to a beneficiary by a provider.

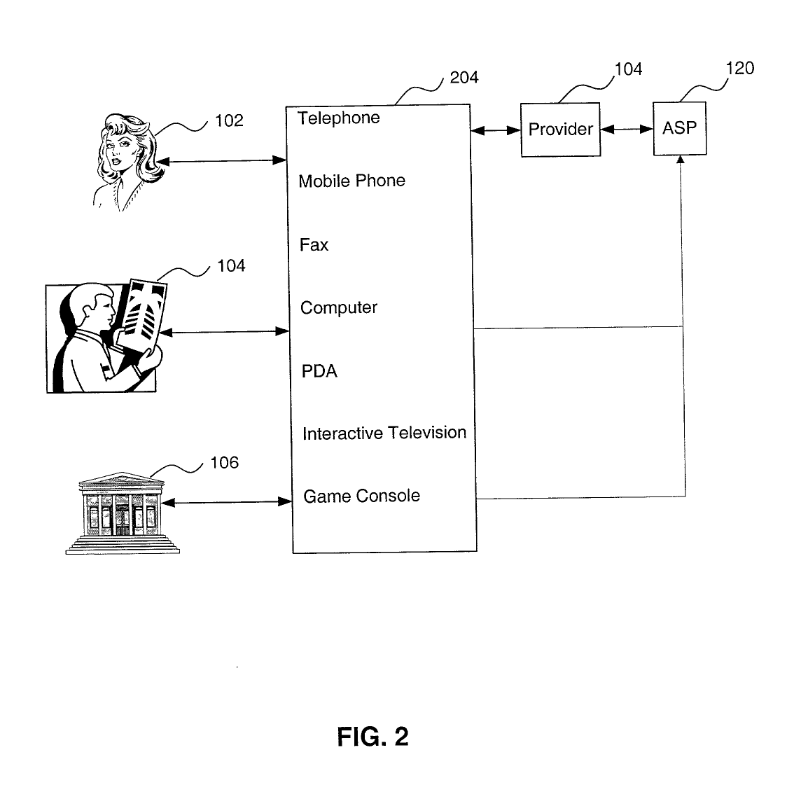

Referring to FIG. 2, a block diagram illustrating the physical architecture of HCPACS 100, according to the ASP embodiment of the present invention, is shown. FIG. 2 shows the various ways in which clients (e.g., a beneficiary 102, a provider 104 or a third party payor 106) can access application service provider 120. A client can be a beneficiary 102 seeking to purchase a health care product from provider 104, a provider 104 seeking to ensure coverage of a beneficiary 102 or a third party payor 106 seeking to verify coverage of a beneficiary 102. The figure shows that a client can use any one of a multitude of connection devices 204 (as described in Table 3) to access and interact with application service provider 120. Through this connection, the client can proceed to comply with the rules by verifying the health care coverage of a beneficiary and insuring payment for the provided health care.

For example, beneficiary 102 can access the web site of provider 104 via a computer, as shown in connection devices 204, connected to the internet. Provider 104 can provide wound care products. Via the web site, beneficiary 102 orders products that were prescribed by her doctor and which are covered by her health plan. Beneficiary 102 enters her personal information (including health insurance information) into the web site and, subsequently, provider 104 contacts application service provider 120 to verify coverage and insure payment for the products. Application service provider 120 then verifies coverage of beneficiary 102 for the products using HCPACS 100. Provider 104 sends the products to beneficiary 102 and third party payor 106 is automatically billed for the provided health care. Additionally, third party payor 106 can automatically pay for the provided health care.

In another example, beneficiary 102 visits a provider 104, such as a doctor, and receives health care. Provider 104 then accesses application service provider 120 directly via a computer, as shown in connection devices 204, connected to the internet. Provider 104 enters the personal information (including health insurance information) of beneficiary 102 into the web site and, subsequently, application service provider 120 verifies coverage of beneficiary 102 for the provided health care using HCPACS 100. Third party payor 106 is subsequently automatically billed for the provided health care. Additionally, third party payor 106 can automatically pay for the provided health care. In yet another example, third party payor 106 accesses application service provider 120 in a way similar to provider 104.

As suggested above, in an embodiment of the present invention, an ASP may provides businesses with access HCPACS 100 of the present invention and charge on a subscriber or per-use basis. In an alternate embodiment, however, the ASP may provide businesses with access to HCPACS 100 of the present invention on an outcome basis. That is, the service provided by HCPACS 100 of the present invention would be monitored in order to calculate a quantitative measurement (i.e., sales numbers) of the effectiveness of the system. Effectiveness would be judged on pre-defined objective outcomes such as sales, consumer visits or session times. Thus, the higher the sales achieved, the more the business would be required to pay to the ASP.

B. Resident Application Model

In an alternate embodiment of the present invention, a stand-alone resident application program is provided to clients which serves as HCPACS 100. The resident application program would provide similar functionality as described herein with reference to the application service provider model mentioned above. In this embodiment of the present invention, the resident application program, instead of being accessed via the global Internet, would run locally on proprietary equipment and be networked among the LAN or WAN (e.g., over an Ethernet, intranet, or extranet) of an entity allowing multiple users to access and use the program. Such software would allow clients to facilitate their own compliance with coverage rules to insure payment by third party payors without necessarily having a subscription to an ASP facility providing the services described herein. Such software would also allow clients to share this information with other entities.

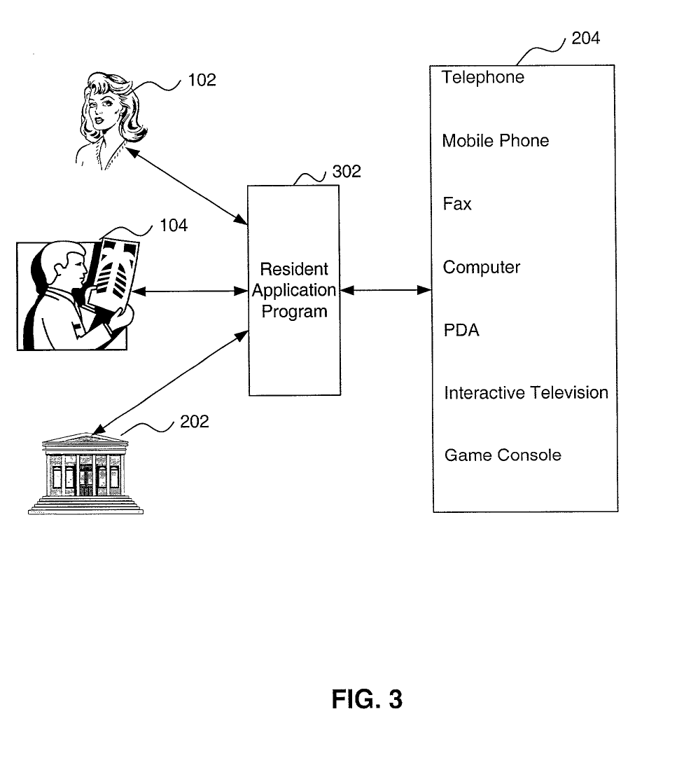

Referring to FIG. 3, a block diagram illustrating the physical architecture of HCPACS 100, according to the resident application program embodiment of the present invention, is shown. FIG. 3 shows clients (e.g., a beneficiary 102, a provider 104 or a third party payor 106) in possession of resident application program 302. In this embodiment, a client can execute resident application program 302 to verify the health care coverage of a beneficiary and insure payment for the provided health care. In addition, clients can proceed to share this information with each other. The figure shows that a client can use any one of a multitude of connection devices 204 (as described in Table 3) to communicate with each other.

For example, provider 104 can be a company which provides wound care products via a web site. Beneficiary 102 can access the web site, via a connection device 204, and order gauze prescribed to her by her doctor. In doing so, beneficiary 102 enters her personal information (including health insurance information) into the web site. Provider 104 then executes resident application program 302 which determines that beneficiary 102 is covered for the products. Provider 104 then sends the gauze to beneficiary 102 and automatically bills third party payor 106 via a connection device 204. Provider 104 can also send third party payor 106 the results of the execution of resident application program 302 in order to ensure payment for the health care provided to beneficiary 102. Additionally, third party payor 106 can automatically pay provider 104 for the provided health care.

III. Compliance Rules

As described above, a third party payor provides its rules governing health care coverage to HCPACS 100. These rules are then applied by HCPACS 100 to insure compliance with the rules and payment by the third party payor. The rules fall into three major categories: General Coverage (GC) rules, Health Plan Coverage (HPC) rules and Specific Payment Criteria (SPC) rules. GC rules generally define when health insurance coverage will apply. GC rules include information such as whether the beneficiary has insurance and the identification number of the beneficiary. HPC rules define what type of coverage is available to the beneficiary. HPC rules include information regarding the specific health plan in which the beneficiary is enrolled, as well as the third party payor of the beneficiary. HPC rules also include co-payment information, deductible information and authorization information. SPC rules define the specific scope of the coverage available to the beneficiary. SPC rules include information regarding whether, in the judgment of the third party payor, the product or service being provided to the beneficiary, or the amount of the product, is appropriate and whether the product or service should be paid for as a benefit.

The three major rule categories are used to sort the different rules into levels of specificity. Whereas GC rules determine whether a beneficiary belongs to a health plan, SPC rules define specifically how a third party payor will pay for covered health care. To this end, the rules are executed in sequence from the most general to the most specific. That is, GC rules are executed first, HPC rules are executed second and SPC rules are executed last. The sequence of execution of the rules is described in greater detail below.

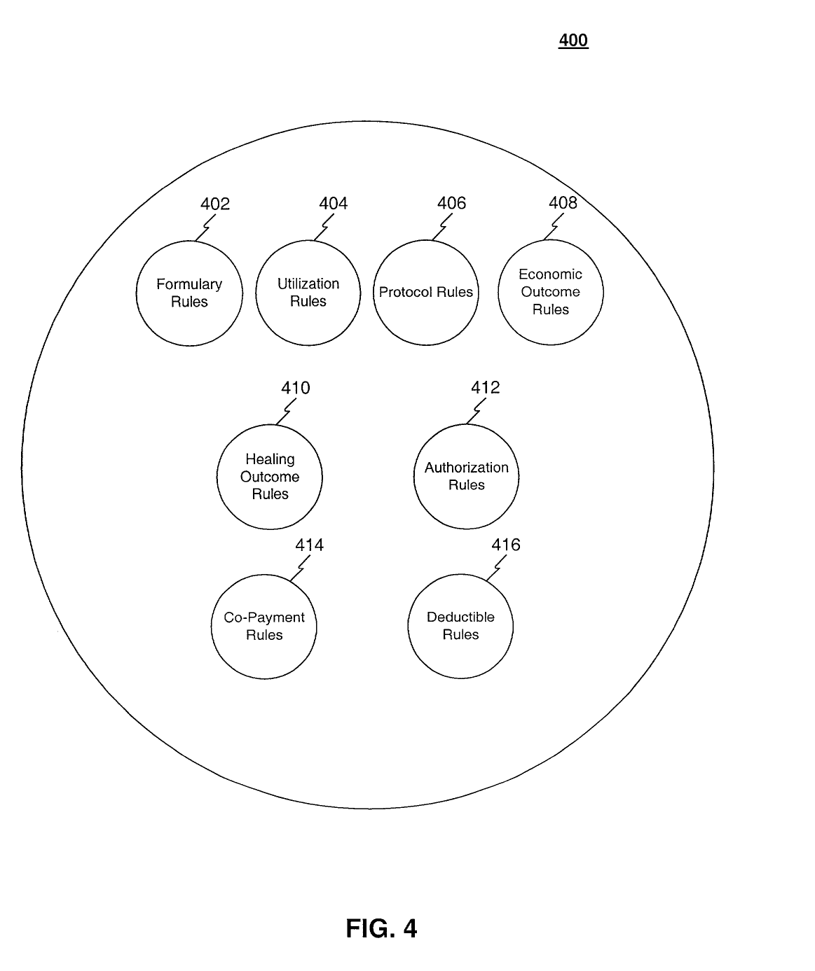

Additionally, the rules governing health care coverage by a third party payor can be further categorized into specific types. Referring to FIG. 4, a diagram illustrating an embodiment of the various types of rules that may be executed by the present invention is shown. FIG. 4 shows a set 400 of rules governing health care coverage that may be executed by the present invention. The different types of rules include Formulary Rules 402, Utilization Rules 404, Protocol Rules 406, Economic Outcome Rules 408, Healing Outcome Rules 410, Authorization Rules 412, Co-Payment Rules 414 and Deductible Rules 416. These rules are described in greater detail above. The rule types are used to sort the different rules into subject type. Thus, whereas a Formulary Rule 402 determines the type of treatment to give a beneficiary, a Deductible Rule 416 determines the amount of money that a beneficiary must pay when purchasing a health care product or service.

Rules of a certain type can pertain to one rule category. That is, the subject of the rule type can be associated with the level of coverage defined by a rule category. For example, Utilization Rules 404 and Protocol Rules 406 tend to also be SPC rules because they specify health care and how coverage applies for that health care. Authorization Rules 412, Co-payment Rules 414 and Deductible Rules 416, however, tend to also be GC rules because they specify whether a beneficiary is covered for certain health care.

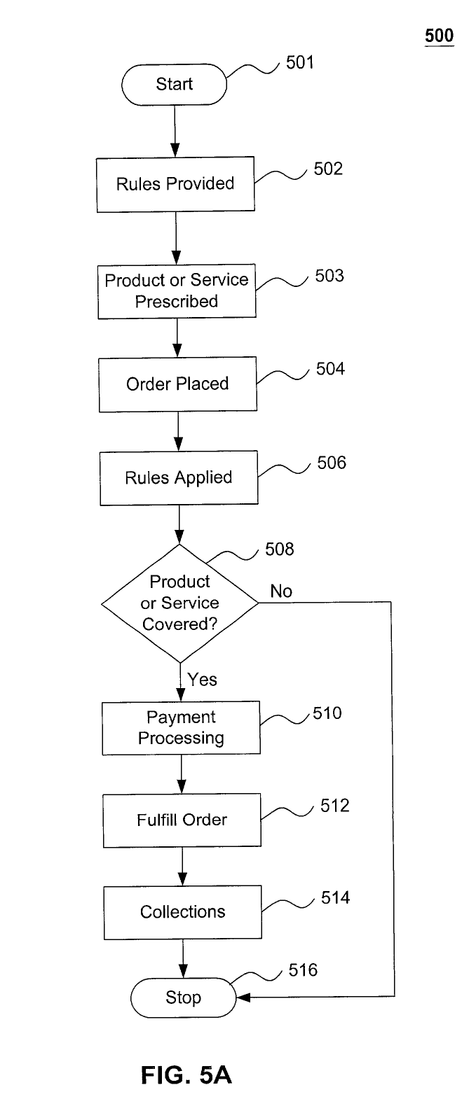

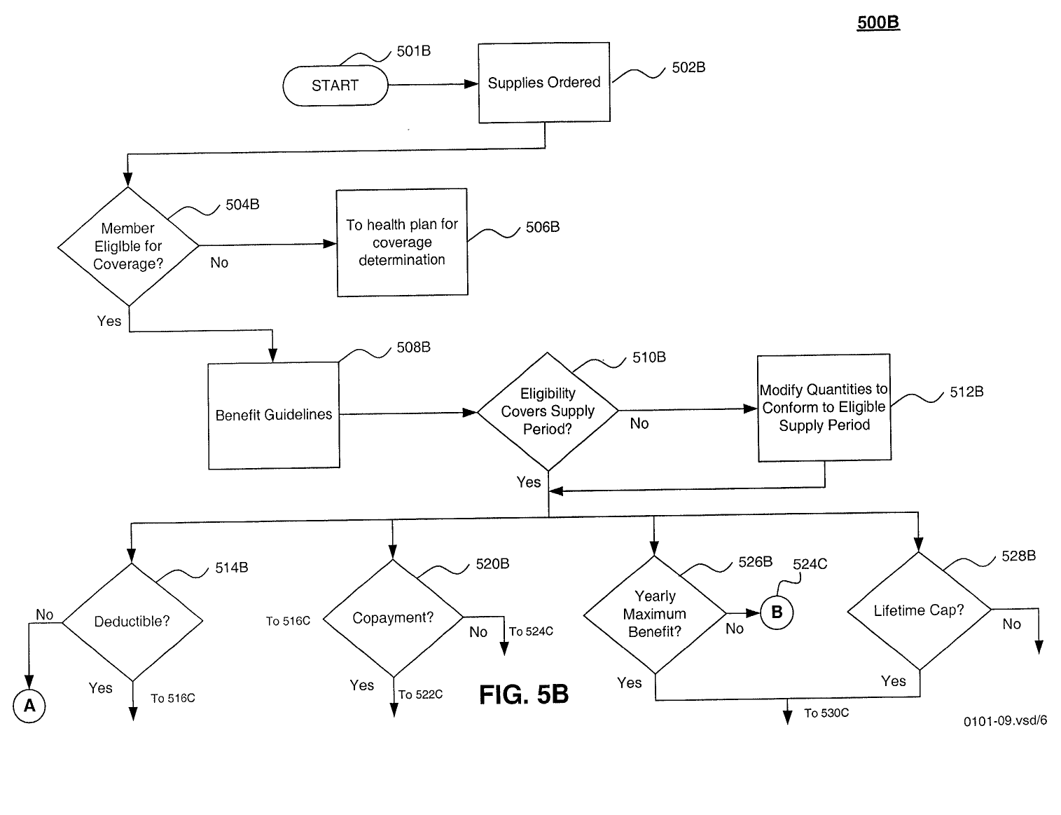

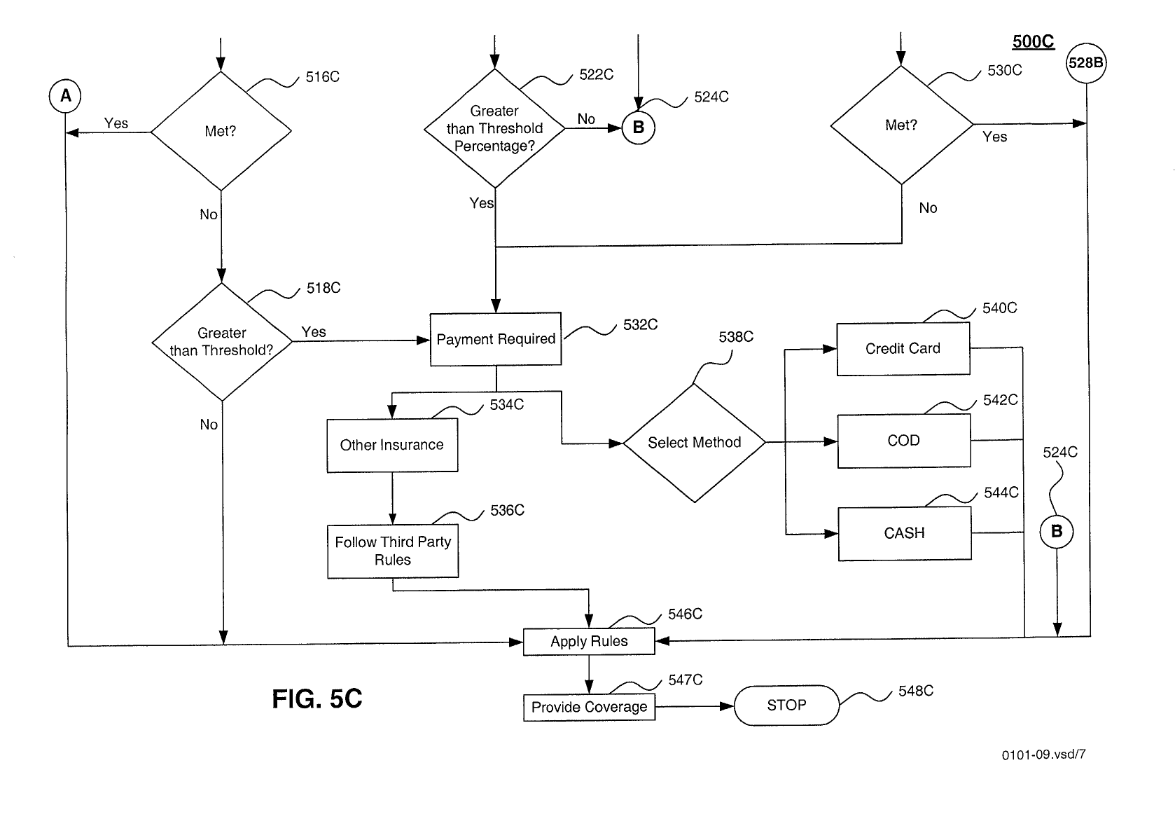

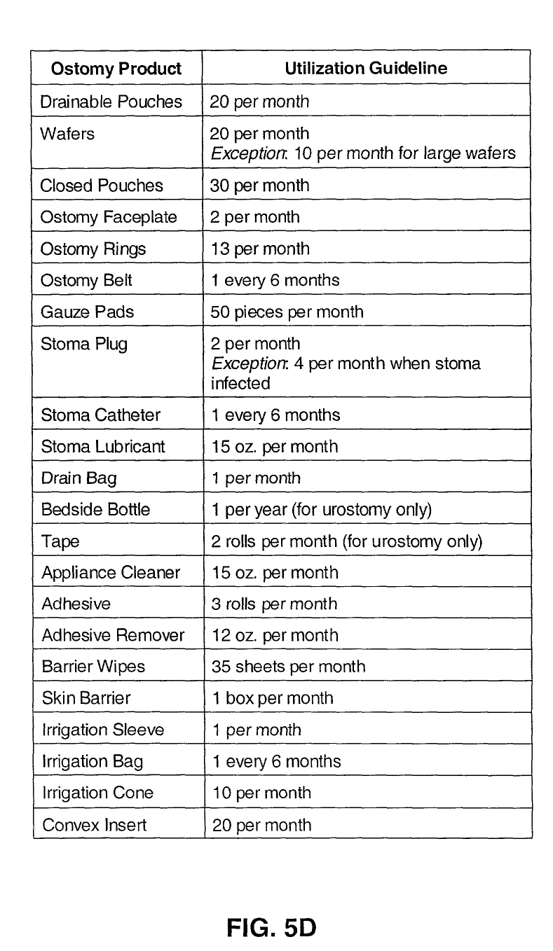

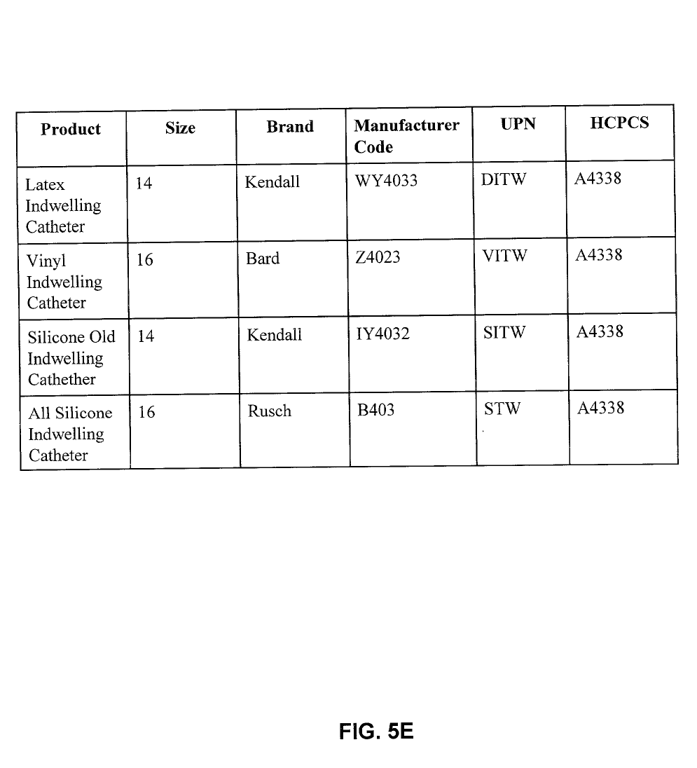

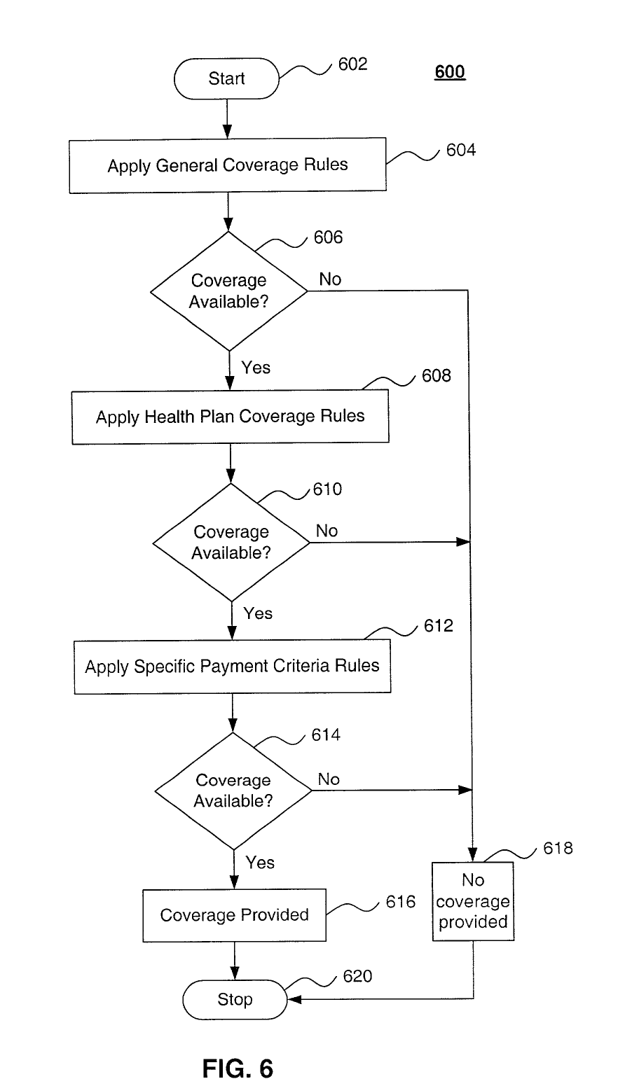

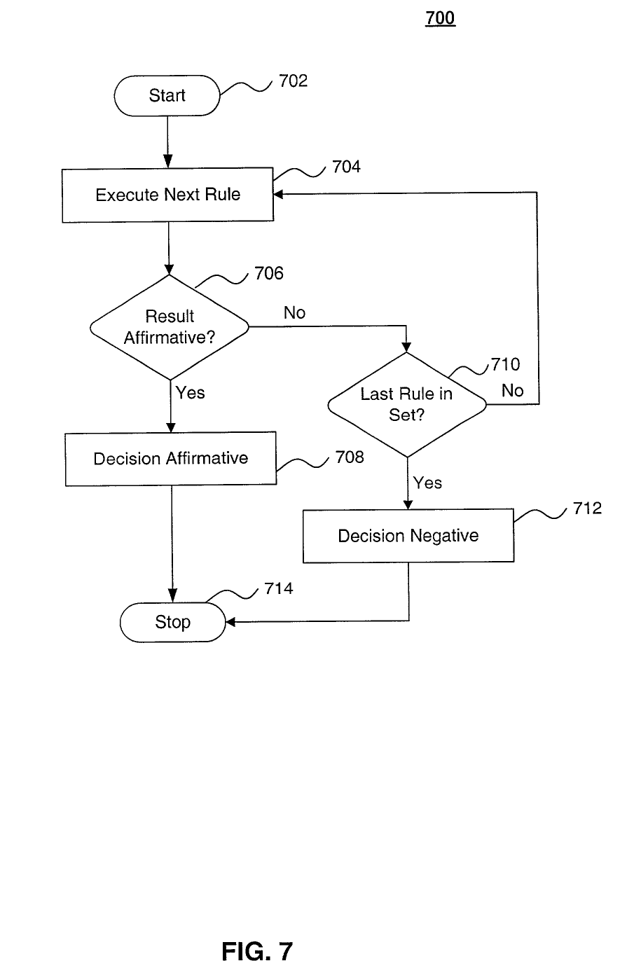

As described above, in an embodiment, a rule consists of a set of conditions and a corresponding action. It should also be noted that rules can have different types of actions. An action may be a simple “affirmative” decision or it may be a statement about how to administer a health care product. Therefore, whereas the action corresponding to a Formulary Rule may 402 be a standard used to administer a certain health care product (i.e., “prescribe only Acme brand gauze”), the action corresponding to an Authorization Rule 412 may be a statement regarding whether an individual possesses health care coverage (i.e., “affirmative,” or “the individual is fully covered for emergency room health care”). Thus, the multitude of rule types described in FIG. 4 can result in a wide range of corresponding actions. The control flows of FIG. 5A, FIG. 5B, FIG. 5C, FIG. 6 and FIG. 7 are directed towards rules that determine health care coverage for a beneficiary and rules that result in affirmative or negative decisions. This is for exemplary purposes only and is not intended to limit the present invention. The present invention supports a wide array of actions ranging from simple affirmative/negative decisions to complex decisions resulting in statements regarding therapeutic use of prescriptive drugs.

IV. System Operation

A. Application Service Provider Model

Referring to FIG. 5A, a flowchart depicting an embodiment of the operation and control flow 500 of HCPACS 100 of the present invention is shown. The embodiment of FIG. 5A represents the ASP model of HCPACS 100. Control flow 500 begins at step 501, with control passing immediately to step 502.

In step 502, third party payor 106 provides its coverage rules to HCPACS 100. These rules can be guidelines (as shown in FIG. 5D), actual rules (as described in greater detail below), or simply policies that govern coverage. Regardless of their form, the coverage rules provided by a third party payor 106 must be placed into a format that is supported by the rules application module (step 506 below) of HCPACS 100. Rule forms are described in greater detail below. HCPACS 100 administrators can also work with third party payors 106 to create and modify rules to facilitate their application by HCPACS 100.

In step 503, a health care product or service is prescribed. This step can entail the transfer of a prescription for a prescriptive device to a beneficiary by a primary care physician. This step can also entail the enrollment of a beneficiary by a physician into an infusion service program. In general, this step involves the beneficiary receiving prescription or other type of order from a physician or other medical-associated personnel to procure a health care product or service. Having received the prescription, the beneficiary then proceeds to procure the health care product or service.

It should be noted that step 502 is optional. That is, it is not always necessary for a beneficiary to receive a prescription for a health care product or service before he can proceed to procure it. In some cases, a beneficiary can simply order a health care product or service directly and request coverage by the third party payor. For example, there are some prescriptive devices, such as orthopedic aids, that are covered by some health insurance plans and do not require prior medical approval before coverage is given. In the case that this step is not executed, control flows directly from step 501 to 504.

In step 504, the beneficiary attempts to procure the health care product or service from a provider by placing an order. This step can entail the beneficiary ordering a health care product from a provider web site. This step can also entail the beneficiary entering a health service facility, such as an infusion service facility, and requesting an infusion service In general, this step involves the beneficiary contacting a provider in order to obtain health care for which he may have a prescription. The beneficiary can use any connection device described in Table 3 and any connection mechanism in Table 4 to place the order with the provider.

The placement of the order can include the submission of various amounts of information necessary for the application of the rules in the following step 506. For example, a Formulary Rule defining the type of drug to use for a particular ailment may require a diagnosis from a physician. In another example, an Authorization Rule may require a prescription from a physician before the prescribed drug is covered. Further examples of information that can be entered into an order are shown in Table 5. The table shows that patient information, third party payor information, coverage information and information regarding the ailment of the beneficiary (such as wound information) can be entered into an order. The table also shows that information regarding the placement of the order (work order information) can be entered so that the order can be tracked and assessed for efficiency and completeness. In sum, the placement of the order can include any information that may be required by any of the coverage rules in order to determine coverage.

Is should be noted that an order for a health care product is typically placed using a code representing the product. The code is generally a SKU code, a NDC code, a UPC code or some other proprietary code used by the provider to identify its products. HIPAA mandates, however, that providers must bill third party payors using HCPCS codes. Thus, in step 504, the provider typically maps the product code used during order intake (whether it be SKU, NDC, UPC or any other proprietary code) to a HCPCS code. This can be accomplished using a computer program or other automated process that can map codes. HCPCS codes, however, are rather general and do not distinguish products having different attributes, such as brand or material. Thus, there is a many-to-one relationship between HCPCS codes and other, more specific, codes such as SKU, UPC and UDC codes. (See FIG. 5E) As a result, there is a loss of information when a more specific code is mapped to a HCPCS code. This information gap is addressed in more detail below.

TABLE 5
Order Placement Information

patient information

id number
name
DOB
phone
address

third party payor information

name
location
phone
type

wound information

wound number
location
type
debridement date
wound progress

wound coverage

start date of wound coverage
level of wound coverage
type of wound

coverage information

start date
end date
insurance type
policy number
group number
policyholder

work order

number
order date
patient
shipping address
item
quantity
bill-to

Alternatively, it may be the case that the provider 104 from which beneficiary 102 attempts to procure health care products or services is also the third party payor 106. In this case, step 504 is executed exactly as described above, except that communication occurs between beneficiary 102 and third party payor 106.

In step 506, the rules governing coverage for the circumstances (as described in order placement step 504) are applied. The manner in which rules are applied is described in greater detail below. It should be noted that in the ASP embodiment of the present invention, step 506 occurs at ASP 120. To enable this, the information garnered by provider 104 during the order intake process of step 405 is transferred to ASP 120 using any of the connection devices described in Table 3 and any of the connection mechanisms described in Table 4.

It should also be noted that in the resident application embodiment of the present invention, step 506 occurs at beneficiary 102, provider 104 or third party payor 106 (as described above). Execution of the process and delivery of the result, therefore, can occur using the connection devices described in Table 3 and the connection mechanisms described in Table 4.

In an embodiment of the present invention, in step 506, HCPACS 100 maps the HCPCS code for the ordered products back to more specific codes such as SKU, UPC and NDC codes. This can be accomplished using a routine which accesses a chart or a database which shows a correspondence between HCPCS codes and more specific codes. However, as described above, there is a many-to-one relationship between HCPCS codes and more specific codes. (See FIG. 5E) This can be overcome by the mapping routine by using information gathered during order intake information in step 504. During order intake, information regarding the ordered product, such as the brand or the material of the product, can be gathered. This information can be used by the mapping routine to determine which specific code one HCPCS code will map to. This information (the more specific codes which correspond to the HCPCS codes) can be saved by HCPACS 100 and used by third party payors 106. This is described in greater detail below.

In step 508, the results of rules application step 506 are determined. As described above, the result of the application of a rule can be a determination of therapeutic use of health care or a determination of coverage of health care. Step 508 is concerned solely with the determination of coverage for the ordered health care. Specifically, step 508 determines whether at least a portion of the value of the ordered health care is covered by the third party payor. If the determination of step 508 is affirmative, control flows directly to step 510. Otherwise, control flows directly to step 516.

In step 510, payment for the ordered health care is processed. Payment processing consists of provider 104 (or whichever entity provided the health care to beneficiary 102) automatically billing third party payor 106 for the covered health care. Payment processing is described in greater detail below. As mentioned above, it should be noted that in the ASP embodiment, step 510 can occur via the connection devices described in Table 3 and the connection mechanisms described in Table 4.

In an embodiment of the present invention, HCPACS 100 can act as a conduit for automatic payment and billing. That is, HCPACS 100 can automatically bill third party payor 106 for covered health care and, upon receipt of payment, forward the payment to provider 104.

In step 512, the order is fulfilled. In the event that a health care product was ordered, the product is given, mailed or delivered to beneficiary 102. In the even that a health care service was ordered, the service is released, administered or provided to beneficiary 102.

In step 514, payment is collected. As described in greater detail below, payment processing consists of either billing third party payor 106 or beneficiary 102. Step 514 involves the collection of payments from either party, if applicable. In an embodiment of the present invention, payment for provided health care is automatically received by provider 104 from third party payor 106 via any connection device described in Table 3 or any connection mechanism described in Table 4. In an alternative embodiment of the present invention, step 514 can be executed by an accounting firm, a collection firm or other third party.

In step 516, control flow 500 ceases.

In an embodiment of the present invention, control flow 500 can include a step which processes future orders based on an initial determination of future need. That is, if a rule determines that a beneficiary will be requiring certain health care over a period of time, future orders can be automatically processed by HCPACS 100. For example, if it is determined that a beneficiary will be requiring delivery of enteral nutrition for a period of a few months, HCPACS 100 can automatically process orders in the future. This step decreases the amount of order processing necessary for recurring orders and decreases the need for the placement of repeated orders by the beneficiary.

In another embodiment of the present invention, HCPACS 100 is applied towards medical benefit coverage, including: durable medical equipment, enteral nutrition, incontinence products, ostomy products, respiratory products, injectable drugs, infusion services, home health care services, wound care management, diabetes management, disease management, health condition management and other specialty health care management. HCPACS 100 is uniquely suited to manage these types of health care because it meets the needs of beneficiaries and providers that are associated with frequent and large orders for a wide range of medical products. Specifically, the wide range of rules that are available to HCPACS 100 make it capable of handling the provision of health care products and services that traditionally do not fall under the pharmacy benefit.

B. Rules Application

As described above, the rules governing health care coverage are divided into three main categories that define hierarchical levels of specificity. As such, the rules, when applied in step 506 above, are applied from the most general to the most specific.

Referring to FIG. 6, a flowchart depicting an embodiment of the operation and control flow 600 of the rules application module of HCPACS 100 of the present invention is shown. The embodiment of FIG. 6 represents the application of rules as described in step 506 (see FIG. 5A). Control flow 600 begins at step 602, with control passing immediately to step 604.

In step 604, the rules within the GC rules category are applied.

In step 606, the level of coverage is determined. If the application of rules in the previous step determined that at least a portion of the value of the ordered health care is covered by the third party payor, then control flows to step 608. Otherwise, control flows to step 618.

In step 608, the rules within the HPC rules category are applied.

In step 610, the level of coverage is determined. If the application of rules in the previous step determined that at least a portion of the value of the ordered health care is covered by the third party payor, then control flows to step 612. Otherwise, control flows to step 618.

In step 612, the rules within the SPC rules category are applied.

In step 614, the level of coverage is determined. If the application of rules in the previous step determined that at least a portion of the value of the ordered health care is covered by the third party payor, then control flows to step 616. Otherwise, control flows to step 618.

In step 616, it is apparent that all three categories of rules (GC, HPC and SPC) have determined that at least a portion of the value of the ordered health care is covered by the third party payor. Thus, the result of flow 600 is that coverage by the third party payor is available to the beneficiary for the ordered products.

In step 618, it is apparent that at least one of the three categories of rules have determined that there is no coverage by the third party payor for the ordered health care. Thus, the result of flow 600 is that coverage by the third party payor is not available to the beneficiary for the ordered products.

In step 620, control flow ceases.

1. Decisions and Rule Sets

The application of rules results in the making of decisions wherein each decision is determined through the application of a corresponding group or rules called rule sets. A decision is a determination that is made regarding one issue. A rule set is a group of rules that are applied in order to make a decision. Therefore, a decision is made by executing the corresponding rule set. For example, a decision can be a determination of whether an individual has adequate health care coverage to cover a particular health care service. The corresponding rule set can be a group of rules, each of which determines whether the individual belongs to a health plan.

Referring to FIG. 7, a flowchart depicting an embodiment of the operation and control flow 700 of the execution of a decision of HCPACS 100 of the present invention is shown. The embodiment of FIG. 7 represents the execution of a single decision within the application of rules as described in step 506 above (see FIG. 5). FIG. 7 shows an example of a decision wherein any affirmative determination by at least one rule within the corresponding rule set renders an affirmative decision. Otherwise, the decision is negative. It should be noted that this embodiment of FIG. 7 is for exemplary purposes only and does not seek to limit the present invention. Decisions in the present invention can be made in a variety of ways. For example, an affirmative decision may require an affirmative determination by all or some of the rules within the corresponding rule set.

Control flow 700 begins at step 702, with control passing immediately to step 704.

In step 704, the next rule within the rule set is applied. The manner is which a rule is applied in described in greater detail below.

In step 706, the result of the above rule is determined. If the determination is affirmative, control flows to step 708. Otherwise, control flows to step 710.

In step 708, the decision is deemed affirmative.

In step 710, it is determined whether the current rule is the last rule in the rule set. If the determination is affirmative, control flows to step 712. Otherwise, control flows back to step 704. In this way, the process iterates through every rule in the rule set until an affirmative decision is reached or every rule is exhausted.

In step 712, the decision is deemed negative.

In step 714, control flow 700 ceases.

2. Individual Rules

As described above, a rule consists of a set of conditions and a corresponding action. As such, a rule is applied by determining whether the conditions are met. If the determination is affirmative, the action is executed.

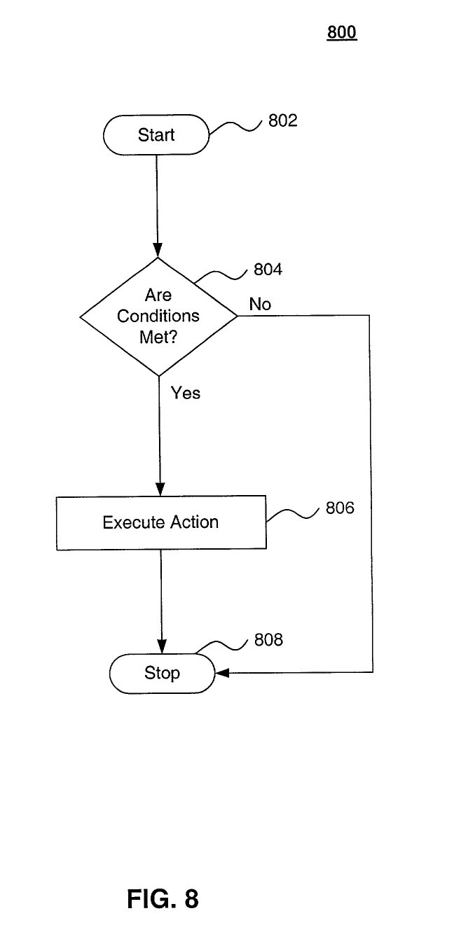

Referring to FIG. 8, a flowchart depicting an embodiment of the operation and control flow 800 of the application of a single rule of HCPACS 100 of the present invention is shown. The embodiment of FIG. 8 represents the application of a single rule within a rule set as described in step 706 (see FIG. 7). Control flow 800 begins at step 802, with control passing immediately to step 804.

In step 804, it is determined whether the conditions are met. If the determination is affirmative, control flows to step 806. Otherwise, control flows to step 808.

In step 806, the action or actions are executed.

In step 808, control flow 800 ceases.

In an example of control flow 800, consider a rule which asserts the following: If the beneficiary possesses a prescription for saline solution, the third party payor shall cover the entire value of the prescribed product. Also consider a beneficiary who possesses a prescription for saline solution from his primary care physician and who submits this prescription to a pharmacy. In this case, step 804 determines that 1) the person is a beneficiary and 2) he possesses a prescription for saline solution. Thus, control flows directly to step 806 and it is asserted that the third party payor will cover the entire value of the saline solution.

C. Payment Processing

Payment processing is executed after liability for the provided health care is assessed. Often, liability for provided health care is divided among beneficiary 102 and third party payor 106.

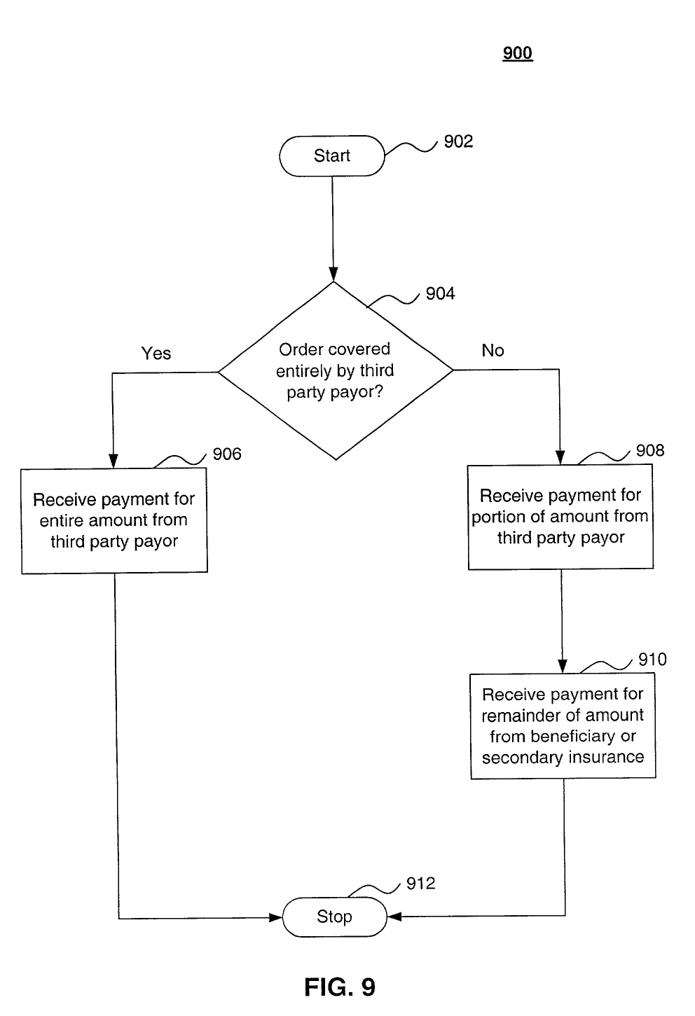

Referring to FIG. 9, a flowchart depicting an embodiment of the operation and control flow 900 of the payment processing module of HCPACS 100 of the present invention is shown. The embodiment of FIG. 9 represents payment processing as described in step 510 (see FIG. 5A). Control flow 900 begins at step 902, with control passing immediately to step 904.

In step 904, it is determined whether third party payor 106 is liable for the entire amount of the provided health care. If the determination is affirmative, control flows to step 906. Otherwise, control flows to step 908.

In step 906, third party payor 106 is liable for the entire amount of the provided health care. Third party payor 106 can automatically send payment to provider 104 via the connection devices in Table 3 and the connection mechanisms in Table 4. In an alternative, third party payor 106 can automatically send provider 104 a promise to pay via the connection devices in Table 3 and the connection mechanisms in Table 4. In another alternative, third party payor 106 can automatically receive a bill from provider 104 via the connection devices in Table 3 and the connection mechanisms in Table 4. In response to this bill, third party payor 106 may then automatically pay provider 104.

In step 908, third party payor 106 is liable for a portion of the amount of the provided health care. Third party payor 106 can automatically send payment to provider 104 via the connection devices in Table 3 and the connection mechanisms in Table 4. In an alternative, third party payor 106 can automatically send provider 104 a promise to pay via the connection devices in Table 3 and the connection mechanisms in Table 4. In another alternative, third party payor 106 can automatically receive a bill from provider 104 via the connection devices in Table 3 and the connection mechanisms in Table 4. In response to this bill, third party payor 106 may then automatically pay provider 104.

In step 910, beneficiary 102 is liable for a portion of the amount of the provided health care. Beneficiary 102 can automatically send payment to provider 104 via the connection devices in Table 3 and the connection mechanisms in Table 4. In an alternative, beneficiary 102 can send provider 104 a promise to pay via the connection devices in Table 3 and the connection mechanisms in Table 4. In another alternative, beneficiary 102 can receive a bill from provider 104 via the connection devices in Table 3 and the connection mechanisms in Table 4.

In step 912, control flow 900 ceases.

It should be noted that, as described above, providers 104 are mandated by HIPAA to bill third party payors 106 for health care products using HCPCS codes. Thus, when a provider 104 bills a third party payor 106 for a health care product provided to a beneficiary 102, third party payor 106 receives only HCPCS information regarding the covered product. As such, the resolution to which third party payors 106 are aware of products for which they have provided coverage is restricted by the resolution of HCPCS codes. As described above, HCPCS codes are rather general and do not distinguish products having different attributes, such as brand or material. Therefore, third party payors 106 are often at a loss for specific information regarding the products for which they provide coverage. This information gap is described in greater detail below.

D. Alternative System Operation

Referring to FIG. 5B, a flowchart depicting an alternative embodiment of the operation and control flow 500B of HCPACS 100 of the present invention is shown. The embodiment of FIG. 5B represents an example of the operation of HCPACS 100, in an alternative to the operation depicted in FIG. 5A. It should be noted that FIG. 5B is continued in FIG. 5C which depicts operation and control flow 500C. Control flow 500B begins at step 501B, with control passing immediately to step 502B.

In step 502B, health care supplies are ordered by a beneficiary.

In step 504B, HCPACS 100 determines whether the beneficiary is eligible for coverage. If this determination is affirmative, control passes to step 508B.

If this determination is negative, control passes to step 506B.

In step 506B, the health plan of the beneficiary manually determines coverage for the beneficiary.

In step 508B, benefit guidelines are consulted. Benefit guidelines, along with an example, are described in greater detail below.

In step 510B, HCPACS 100 determines, based on step 508B, whether the beneficiary is eligible for the supply period for which he is requesting supplies. If this determination is affirmative, control passes to each of step 514B, 520B, 526B and 528B. That is, each of steps 514B, 520B, 526B and 528B, and the steps that proceed from them, are executed in parallel. If this determination is negative, control passes to step 512B.

In step 512B, HCPACS 100 modifies the quantities of the requested health care supplies to conform to the eligible supply period.

In step 514B, HCPACS 100 determines whether there is a deductible. If this determination is affirmative, control passes to 516C. If this determination is negative, control passes to step 546C.

In step 516C, HCPACS 100 determines whether the deductible above has been met. If this determination is affirmative, control passes to 546C. If this determination is negative, control passes to step 518C.

In step 518C, HCPACS 100 determines whether the deductible above is greater than a threshold value. If this determination is affirmative, control passes to 532C. If this determination is negative, control passes to step 546C.

In step 520B, HCPACS 100 determines whether there is a co-payment.

If this determination is affirmative, control passes to 522C. If this determination is negative, control passes to step 524C.

In step 522C, HCPACS 100 determines whether the co-payment above is greater than a threshold percentage. If this determination is affirmative, control passes to 532C. If this determination is negative, control passes to step 524C.

In step 526B, HCPACS 100 determines whether there is a yearly maximum benefit. If this determination is affirmative, control passes to 530C.

If this determination is negative, control passes to step 524C.

In step 528B, HCPACS 100 determines whether there is a lifetime cap.

If this determination is affirmative, control passes to 530C. If this determination is negative, control passes to step 546C.

In step 530C, HCPACS 100 determines whether the respective maximums above have been met. If this determination is affirmative, control passes to 546C.

If this determination is negative, control passes to step 532C.

In step 532C, payment is required by the beneficiary.

In step 534C, a secondary insurance of the beneficiary covers the ordered health care supplies.

In step 536C, third party rules (the rules of the secondary insurance) are applied.

In step 538C, the method of payment is selected by the beneficiary.

In step 540C, a credit card is used for payment.

In step 542C, COD is used for payment.

In step 544C, cash is used for payment.

In step 546C, the remaining coverage rules are applied by HCPACS 100.

This can include the rules that are depicted in FIG. 6.

In step 547C, the coverage determined by HCPACS 100 above is provided by the third party payor.

In step 548C, control flow 500B and 500C ceases.

Referring to FIG. 5D, a chart depicting an embodiment of utilization guidelines for ostomy care, in an embodiment of the present invention, is shown.

In the left column, the figure shows ostomy care products that are covered by a health plan. In the right column, the figure shows utilization guidelines for each ostomy care product. It can be seen that the utilization guidelines define how much and how often certain products can be administered and remain within the coverage of the health plan. These guidelines, therefore, are used by HCPACS 100 to determine which products, and which quantities of products, are covered by a health plan. It can also be seen, in the right column, that exceptions to guidelines can also be applied.

The information within the chart of FIG. 5D is typically provided by a third party payor 106. In an embodiment of the present invention, the information within the chart of FIG. 5D is given to ASP 120 by third party payor 106 for entry into rules database 112. This information may then by accessed by HCPACS 100 during rules application, as described in step 546C (see FIG. 5C) and step 506 (see FIG. 5A).

D. Product Tracking Module

Referring to FIG. 5E, a chart depicting an embodiment of a product code mapping, in an embodiment of the present invention, is shown. FIG. 5E shows a chart that can be used by provider 104 (as described in step 504; see FIG. 5) or HCPACS 100 (as described in step 506) to map product codes from one format to another. FIG. 5E shows a list of products and the corresponding product codes. The chart shows that four different products having different attributes (such as size, brand and material) can have the same HCPCS code associated with it. Conversely, the chart shows that each of the products has a unique UPN and manufacturer code associated with it. This shows the existence of a many-to-one relationship between HCPCS codes and other, more specific codes. As a result, information is lost when more specific codes are mapped to HCPCS codes but information is gained when HCPCS codes are mapped to more specific codes.

In an embodiment of the present invention, the information gathered by HCPACS 100, regarding more specific codes corresponding to covered products, is used by third party payors 106. As described above, during rules application in step 506, HCPACS 100 maps the HCPCS codes of products, for which third party payors 106 are providing coverage, to more specific codes such as SKU, UPC and UDC codes. This information is saved by HCPACS 100 and can be provided to third party payors 106.

Currently, third party payors 106 do not possess information regarding the specific products for which they are providing coverage. As described above, because providers 104 must bill third party payors 106 using HCPCS codes, which are rather general, third party payors 106 only possess general information regarding the products for which they are providing coverage. This hinders the ability of a third party payor 106 to negotiate with manufacturers 160 (see FIG. 1C).

In this embodiment, third party payors 106 access the specific product code information saved by HCPACS 100. Using this information, third party payors 106 are better able to determine which products and product quantities are being ordered by beneficiaries 102. Armed with this information, third party payors 106 can negotiate with manufacturers 160 for lower prices on specific products and better service. This translates to better service provided by third party payors 106, cheaper products for beneficiaries and increased sales for manufacturers.

VII. Example Implementations

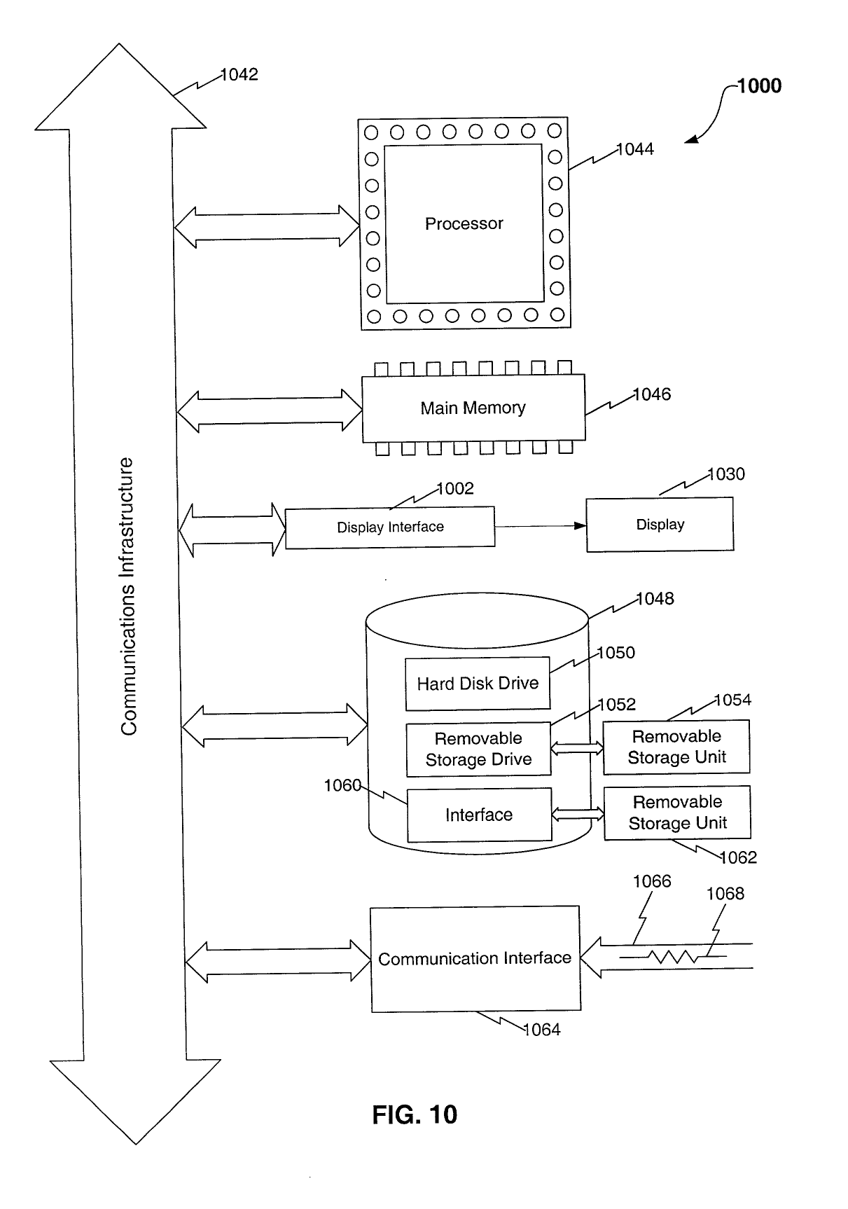

The present invention (i.e., HCPACS 100, flow 500, flow 600, flow 700, flow 800, flow 900 or any part thereof) may be implemented using hardware, software or a combination thereof and may be implemented in one or more computer systems or other processing systems. In fact, an example of a computer system 1000 is shown in FIG. 10. The computer system 1000 represents any single or multi-processor computer. In conjunction, single-threaded and multi-threaded applications can be used. Unified or distributed memory systems can be used. Computer system 1000, or portions thereof, may be used to implement the present invention. For example, the HCPACS 100 of the present invention may comprise software running on a computer system such as computer system 1000.

In one example, HCPACS 100 of the present invention is implemented in a multi-platform (platform independent) programming language such as JAVA™, programming language/structured query language (PL/SQL), hyper-text mark-up language (HTML), practical extraction report language (PERL), Flash programming language, common gateway interface/structured query language (CGI/SQL) or the like. Java™-enabled and JavaScript™-enabled browsers are used, such as, Netscape™, HotJava™, and Microsoft™ Explorer™ browsers. Active content Web pages can be used. Such active content Web pages can include Java™ applets or ActiveX™ controls, or any other active content technology developed now or in the future. The present invention, however, is not intended to be limited to Java™, JavaScript™, or their enabled browsers, and can be implemented in any programming language and browser, developed now or in the future, as would be apparent to a person skilled in the relevant art(s) given this description.

In another example, the HCPACS 100 of the present invention, may be implemented using a high-level programming language (e.g., C++) and applications written for the Microsoft Windows™ NT or SUN™ OS environments. It will be apparent to persons skilled in the relevant art(s) how to implement the invention in alternative embodiments from the teachings herein.

Computer system 1000 includes one or more processors, such as processor 1044. One or more processors 1044 can execute software implementing the routines described above, such as shown in FIGS. 5, 6, 7, 8 and 9. Each processor 1044 is connected to a communication infrastructure 1042 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1000 can include a display interface 1002 that forwards graphics, text, and other data from the communication infrastructure 1042 (or from a frame buffer not shown) for display on the display unit 1030.

Computer system 1000 also includes a main memory 1046, preferably random access memory (RAM), and can also include a secondary memory 1048.

The secondary memory 1048 can include, for example, a hard disk drive 1050 and/or a removable storage drive 1052, representing a floppy disk drive, a magnetic tape drive, an optical disk drive, etc. The removable storage drive 1052 reads from and/or writes to a removable storage unit 1054 in a well known manner. Removable storage unit 1054 represents a floppy disk, magnetic tape, optical disk, etc., which is read by and written to by removable storage drive 1052. As will be appreciated, the removable storage unit 1054 includes a computer usable storage medium having stored therein computer software and/or data.

In alternative embodiments, secondary memory 1048 may include other similar means for allowing computer programs or other instructions to be loaded into computer system 1000. Such means can include, for example, a removable storage unit 1062 and an interface 1060. Examples can include a program cartridge and cartridge interface (such as that found in video game console devices), a removable memory chip (such as an EPROM, or PROM) and associated socket, and other removable storage units 1062 and interfaces 1060 which allow software and data to be transferred from the removable storage unit 1062 to computer system 1000.

Computer system 1000 can also include a communications interface 1064. Communications interface 1064 allows software and data to be transferred between computer system 1000 and external devices via communications path 1066. Examples of communications interface 1064 can include a modem, a network interface (such as Ethernet card), a communications port, interfaces described above, etc. Software and data transferred via communications interface 1064 are in the form of signals which can be electronic, electromagnetic, optical or other signals capable of being received by communications interface 1064, via communications path 1066. Note that communications interface 1064 provides a means by which computer system 1000 can interface to a network such as the Internet.

The present invention can be implemented using software running (that is, executing) in an environment similar to that described above with respect to FIGS. 5, 6, 7, 8 and 9. In this document, the term “computer program product” is used to generally refer to removable storage unit 1054, a hard disk installed in hard disk drive 1050, or a carrier wave carrying software over a communication path 1066 (wireless link or cable) to communication interface 1064. A computer useable medium can include magnetic media, optical media, or other recordable media, or media that transmits a carrier wave or other signal. These computer program products are means for providing software to computer system 1000.

Computer programs (also called computer control logic) are stored in main memory 1046 and/or secondary memory 1048. Computer programs can also be received via communications interface 1064. Such computer programs, when executed, enable the computer system 1000 to perform the features of the present invention as discussed herein. In particular, the computer programs, when executed, enable the processor 1044 to perform features of the present invention. Accordingly, such computer programs represent controllers of the computer system 1000.

The present invention can be implemented as control logic in software, firmware, hardware or any combination thereof. In an embodiment where the invention is implemented using software, the software may be stored in a computer program product and loaded into computer system 1000 using removable storage drive 1052, hard disk drive 1050, or interface 1060. Alternatively, the computer program product may be downloaded to computer system 1000 over communications path 1066. The control logic (software), when executed by the one or more processors 1044, causes the processor(s) 1044 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

VIII. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A computer-based method for facilitating compliance with rules governing coverage by a third party payor for health care provided to a beneficiary by a provider, wherein the health care is administered under the medical benefit, comprising the steps of:
(1) receiving an order for the health care;
(2) applying the rules associated with said order;
(3) determining the level of coverage by the third party payor for said order;
(4) processing payment for said order; and
(5) processing fulfillment of said order.

2. The computer-based method of claim 1, wherein said step (1) comprises receiving an order for the health care from at least one of:
the beneficiary; and
the provider.

3. The computer-based method of claim 1, wherein said step (1) comprises receiving an order including:
(a) beneficiary information;
(b) third party payor information;
(c) prescription information associated with the health care;
(d) disease or wound information associated with the health care; and
(e) information associated with the health care.

4. The computer-based method of claim 3, wherein said information associated with the health care comprises a HCPCS product code corresponding to the health care.

5. The computer-based method of claim 4, wherein said HCPCS product code is mapped to a more specific product code.

6. The computer-based method of claim 5, wherein said more specific product code is provided to the third party payor.

7. The computer-based method of claim 1, wherein the rules governing coverage comprise:
protocol rules;
healing outcome rules; and
economic outcome rules.

8. The computer-based method of claim 7, wherein the rules governing coverage further comprise:
formulary rules;
utilization rules;
authorization rules;
co-payment rules; and
deductible rules.

9. The computer-based method of claim 1, wherein said step (4) comprises at least one of:
(f) receiving payment to the provider from the third party payor for the portion of the value of the health care covered by the third party payor; wherein said portion is determined by said step (3);
(g) receiving a promise to pay the provider from the third party payor for the portion of the value of the health care covered by the third party payor; wherein said portion is determined by said step (3); and
(h) sending a bill from the provider to the third party payor for the portion of the value of the health care covered by the third party payor; wherein said portion is determined by said step (3).

10. The computer-based method of claim 9, wherein said step (4) further comprises:
receiving payment to the provider from the beneficiary for the portion of the value of the health care not covered by the third party payor, if the third party payor does not completely cover the value of the health care, wherein said portion is determined by said step (3).

11. The computer-based method of claim 1, wherein said step (5) comprises:
initiating the sending of the health care product from the provider to the beneficiary.

12. The computer-based method of claim 1, wherein said step(5) comprises:
initiating the release of the health care service from the provider to the beneficiary.

13. The computer-based method of claim 1, further comprising:
automatically processing fulfillment of future orders determined by said step (3).

14. The computer-based method of claim 1, wherein the method is applied to ancillary health care.

15. A computer system for facilitating compliance with rules governing coverage by a third party payor for health care provided to a beneficiary by a provider, wherein the health care is administered under the medical benefit, said comprising: means for receiving an order for the health care;
means for applying the rules associated with said order;
means for determining the level of coverage by the third party payor for said order;
means for processing payment for said order; and
means for processing fulfillment of said order.

16. The computer system of claim 15, wherein the rules governing coverage comprise:
protocol rules;
healing outcome rules; and
economic outcome rules.

17. The computer system of claim 16, wherein the rules governing coverage further comprise:
formulary rules;
utilization rules;
authorization rules;
co-payment rules; and
deductible rules.

18. The computer system of claim 15, further comprising:
means for converting a first product code submitted with said order to a more specific product code.

19. The computer system of claim 18, further comprising:
means for providing said more specific product code to the third party payor.

20. The computer system of claim 15, wherein the system is used for ancillary health care.

21. A computer program product comprising a computer useable medium having control logic stored therein for causing a computer to facilitate compliance with rules governing coverage by a third party payor for health care provided to a beneficiary by a provider, wherein the health care is administered under the medical benefit, the computer control logic comprising:
first computer readable program code means for causing the computer to receive an order for the health care;
second computer readable program code means for causing the computer to apply the rules associated with said order;
third computer readable program code means for causing the computer to determine the level of coverage by the third party payor for said order;
fourth computer readable program code means for causing the computer to process payment for said order; and
fifth computer readable program code means for causing the computer to process fulfillment of said order.

22. The computer program product of claim 21, wherein the rules governing coverage comprise:
protocol rules;
healing outcome rules; and
economic outcome rules.

23. The computer program product of claim 22, wherein the rules governing coverage further comprise:
formulary rules;
utilization rules; authorization rules;
co-payment rules; and
deductible rules.

24. The computer program product of claim 21, further comprising:
computer readable program code means for causing the computer to convert a first product code submitted with said order to a more specific product code; and
computer readable program code means for causing the computer to provide said more specific product code to the third party payor.

25. The computer program product of claim 21, wherein said fifth computer readable program code means comprises:
computer readable program code means for causing the computer to initiate the sending of the health care product from the provider to the beneficiary.

26. The computer program product of claim 21, wherein said fifth computer readable program code means comprises:
computer readable program code means for causing the computer to initiate the release of the health care service from the provider to the beneficiary.

27. The computer program product of claim 21, the computer control logic further comprising:
computer readable program code means for causing the computer to automatically process fulfillment of future orders determined by third computer readable program code means.

28. The computer program product of claim 21, wherein the computer program product is applied to ancillary health care.
